(19) United States
(12) Patent Application Publication
(10) Pub. No.: US 2004/0037223 A1
(43) Pub. Date: Feb. 26, 2004

(54) Edge-to-edge traffic control for the internet

(76) Inventors: David Harrison, Troy, NY (US); Shiykumar Kalyanaraman, Albany, NY (US); Sthanunathan Ramakrishanan, Troy, NY (US); Prasad Bagal, Karnataka (IN)

Correspondence Address: Jon D Grossman, Dickstein Shapiro Morin & Oshinsky, 2101 L Street NW, Washington, DC, 20037-1526, US

(21) Appl. No.: 10/204,222

(22) PCT Filed: Feb. 28, 2001
(86) PCT No.: PCT/US01/06263

(51) Int. Cl. H04L 1/00

(52) U.S. Cl. 370/235; 370/412

(57) ABSTRACT

A new overlay apparatus and method to augment best-effort congestion control and Quality of Service in the Internet called edge-to-edge traffic control (FIG. 3) is disclosed. The basic architecture works at the network layer and involves pushing congestion back from the interior of a network, distributing across edge nodes (202, 206, FIG. 3) where the smaller congestion problems can be handled with flexible, sophisticated and cheaper methods. The edge-to-edge traffic trucking building blocks thus created can be used as basis of the several applications. These applicaitons include controlling TCP and non-TCP flows, improving buffer management scalability, developing simple differentiated services, and isolating bandwidth-based denial-of-service attacks. The methods are flexible, combinable with other protocols (like MPLS and diff-serv), require no standardization and can be quickly deployed.

### BACKGROUND OF THE INVENTION

I. Field of the Invention

The present invention generally relates to computer network traffic management and control. In particular, the present invention relates to providing a method to improve computer network traffic congestion and computer network Quality of Service (QoS).

II. Description of the Related Art

Computer network traffic congestion is widely perceived as a non-issue today (especially in the ISP industry) because of the dramatic growth in bandwidth and the fact that many of the congestion spots are peering points which are not under the direct control of a single service provider. However, congestion will continue to increase and in some key spots, namely access links, tail circuits (to remote locations), international circuits and peering points, may ultimately pose unacceptable data network delay. As long as congestion exists at any point along an edge-to-edge path, there exists a need to relieve that congestion and to improve the Quality-of-Service (QoS) to avoid more serious delays as Internet usage continues to grow.

### SUMMARY OF THE INVENTION

The present invention provides a congestion control and Quality of Service apparatus and method which employ a best-effort control technique for the Internet called edge-to-edge traffic control. (In, the present invention, Congestion control and QoS are implemented together as a unitary apparatus and method.) The basic apparatus and method of the present invention works at the network layer and involves pushing congestion back from the interior of a network, and distributing the congestion across edge nodes where the smaller congestion problems can be handled with flexible, sophisticated and cheaper methods. In particular, the apparatus and method of the present invention provide for edge-to-edge control for isolated edge-controlled traffic (a class of cooperating peers) by creating a queue at potential bottlenecks in a network spanned by edge-to-edge traffic trucking building blocks, herein referred to as virtual links, where the virtual links set up control loops between edges and regulate aggregate traffic passing between each edge-pair, without the participation of interior nodes. These loops are overlaid at the network (IP) layer and can control both Transmission Control Protocol (TCP) and non-TCP traffic.

The operation of the overlay involves the exchange of control packets on a per-edge-to-edge virtual link basis. To construct virtual links the present invention uses a set of control techniques which break up congestion at interior nodes and distribute the smaller congestion problems across the edge nodes.

The edge-to-edge virtual links thus created can be used as the basis of several applications. These applications include controlling TCP and non-TCP flows, improving buffer management scalability, developing simple differentiated services, and isolating bandwidth-based denial-of-service attacks. The apparatus and methods of the present invention are flexible, combinable with other protocols (like MPLS and diff-serv), require no standardization and can be quickly deployed.

Thus, the buffers at the edge nodes are leveraged during congestion in order to increase the effective bandwidth-delay product of the network. Further, these smaller congestion problems can be handled at the edge(s) with existing buffer management, rate control, or scheduling methods. This improves scalability and reduces the cost of buffer management. By combining virtual links with other building blocks, bandwidth-based denial of service attacks can be isolated, simple differentiated services can be offered, and new dynamic contracting and congestion-sensitive pricing methods can be introduced. The above system and method may be implemented without upgrading interior routers or end-systems.

### BRIEF DESCRIPTION OF THE DRAWINGS

The foregoing and other advantages and features of the invention will become more apparent from the detailed description of exemplary embodiments provided below with reference to the accompanying drawings in which:

FIG. 1 illustrates a network system for the implementation of the congestion control and Quality of Service methods of the present invention;

FIG. 2 illustrates another view of a network system for the implementation of the congestion control and Quality of Service methods for a class of the present invention;

FIG. 3 illustrates a detailed network system to for use in describing the congestion control and Quality of Service methods for a class with ingress and egress traffic shown in accordance with the present invention;

FIG. 4 shows a chart illustrating dynamic edge-to-edge regulation;

FIG. 5(a) illustrates a queue at a bottleneck; and

FIG. 5(b) illustrates a queue distributed across edges.

### DETAILED DESCRIPTION OF THE INVENTION

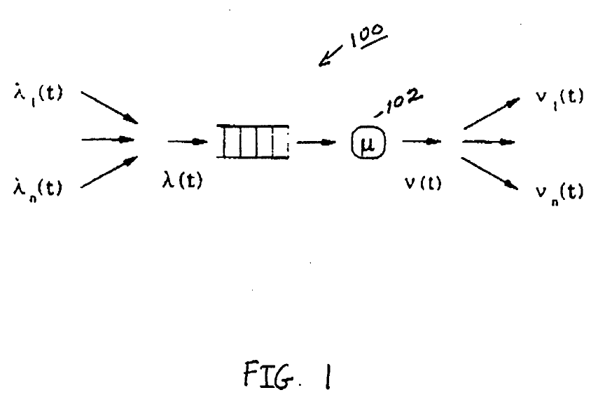

Referring now to the drawings, where like reference numerals designate like elements, there is shown in FIG. 1 a network node bottleneck 100.

The present invention is based upon the observation that at all times, the sum of the output rates of flows passing through a particular single network node bottleneck 100 is less than or equal to the capacity of (μ) 102 at the bottleneck 100, as illustrated in FIG. 1. Most importantly, this condition holds during periods of congestion called “congestion epochs”. For purposes of this disclosure a “congestion epoch” is defined as any period when the instantaneous queue length exceeds a queue bound which is larger than the maximum steady state queue fluctuations. Chosen this way, the congestion epoch is the period of full utilization incurred when the mean aggregate load (λ) at a single bottleneck 100 exceeds mean capacity (μ). Congestion epoch does not involve packet loss in its definition and is a basis for “early” detection. In addition, for simplicity of explanation herein, a single bottleneck 100 is used in the following description, although the present invention is applicable to a network of bottlenecks 100 as well.

The output rates of flows (νᵢ) can be measured at the receiver and fed back to the sender. During congestion epochs each sender imposes a rate limit rᵢ such that rᵢ←min(βν_{i,}, rᵢ) where β<1. If each sender consistently constrains its input rate (λᵢ) such that λᵢ≦rᵢ during the congestion epoch, the epoch will eventually terminate. This is intuitively seen in an idealized single bottleneck, zero-time delay system because the condition Σβνᵢ<Σνᵢ≦μ causes queues to drain. In the absence of congestion, additive increase is employed to probe for the bottleneck capacity limits.

The increase-decrease policy of the present invention is not the same as the well known additive-increase multiplicative-decrease (AIMD) policy, because the decrease policy of the present invention is based upon the output rate (νᵢ) and not the input rate (λᵢ). The policy of the present invention is hereto referred to as AIMD-ER (Additive Increase and Multiplicative Decrease using Egress Rate).

The remaining part of the basic approach is a method to detect the congestion epochs in the system. The present invention utilizes two method for this purpose. The first method assumes that the interior routers assist in the determination of the start and duration of a congestion epoch. In the second method, edges detect congestion epochs without the involvement of interior routers. Specifically, in the first method, the interior router promiscuously marks a bit in packets whenever the instantaneous queue length exceeds a carefully designed threshold.

The second method does not involve support from interior routers. To detect the beginning of a congestion epoch, the edges rely on the observation that each flow's contribution to the queue length (or accumulation), qᵢ, is equal to the integral ∫(λᵢ,(T)−vᵢ(T))dT. If this accumulation is larger than a predefined threshold, the flow assumes the beginning of a congestion epoch. The end of the congestion epoch is detected when a one-way delay sample comes close to the minimum one-way delay.

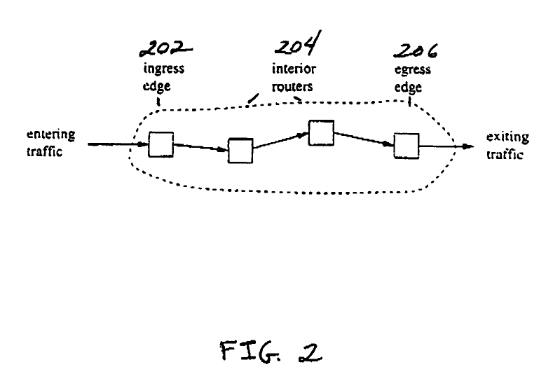

The present invention assumes that the network architecture is partitioned into traffic control classes. A traffic control class is a set of networks with consistent policies applied by a single administrative entity or cooperating administrative entities or peers. Specifically, it is assumed that edge-to-edge controlled traffic is isolated from other traffic which is not edge-to-edge controlled. As illustrated in FIG. 2, the architecture has three primary components: the ingress edge 202, the interior router 204, and the egress edge 206. Nodes within a traffic control class that are connected to nodes outside the class and implement edge-to-edge control are known as edge routers 202, 206. Any remaining routers within a class are called interior routers 204. The methods of the present invention can be implemented on conventional hardware such as that of FIG. 2, where the ingress edge 202, the interior router 204, and egress edge 206 employ the means for performing the methods herein described.

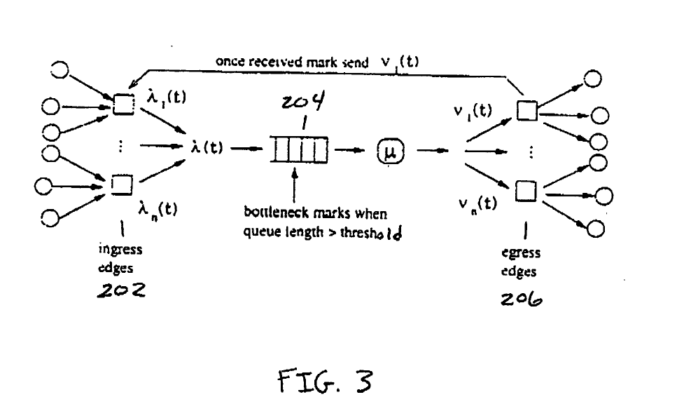

As shown in FIG. 3, under this method, the ingress node 202 regulates each edge-to-edge virtual link to a rate limit of rᵢ. The actual input rate (i.e. departure rate from the ingress 202, and denoted λᵢ) may be smaller than rᵢ. The present invention also assumes that the ingress node 202 uses an observation interval T for each edge-to-edge virtual link originating at this ingress 202.

Under the first method, a congestion epoch begins when an interior router promiscuously marks a congestion bit on all packets once the instantaneous queue exceeds a carefully designed queue threshold parameter. Since interior routers 204 participate explicitly, the present invention refers to this as the Explicit Edge Control (EEC) method. The egress node 206 declares the beginning of a new congestion epoch upon seeing the first packet with the congestion bit set. A new control packet is created and the declaration of congestion along with the measured output rate at the egress 206 is fed back to the ingress 202. The interval used by the egress node 206 to measure and average the output rate is resynchronized with the beginning of this new congestion epoch.

The congestion epoch continues in every successive observation interval where at least one packet from the edge-to-edge virtual link is seen with the congestion bit set. At the end of such intervals, the egress 206 sends a control packet with the latest value of the exponentially averaged output rate. The default response of the ingress edge 202 upon receipt of control packets is to reduce the virtual link's rate limit (rᵢ) to the smoothed output rate scaled down by a multiplicative factor (νᵢ×3:0<β<1). The congestion epoch ends in the first interval when no packets from the link are marked with the congestion bit. The egress 206 merely stops sending control packets and the ingress 202 assumes the end of a congestion epoch when two intervals pass without seeing a control packet.

The ingress node 202 uses a leaky bucket rate shaper whose rate limit (r) can be varied dynamically based upon feedback. The amount of traffic “I” entering the network over any time interval [t, t+T] after shaping is:

I[t,t+r]≦∫ₜ^{t+r}r(T)dT+σ (1)

In inequality 1, r is the dynamic rate limit and σ is the maximum burst size admitted into the network. Assuming that all virtual links are rate-regulated, the queue threshold parameter can be set as Nσ where N is the number of virtual links, not end-to-end flows, passing through the bottleneck. A rough estimate of N, which suffices for this method, can be based upon the number of routing entries, and/or the knowledge of the number of edges whose traffic passes through the node. The objective is to allow at most σ burstiness per active virtual link before signaling congestion.

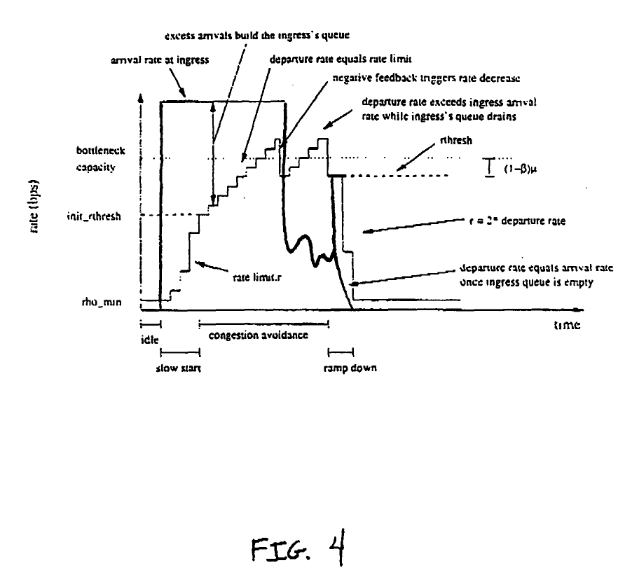

The initialization of edge-to-edge virtual links occurs in a manner similar to TCP slow start, and is defined by the present invention as “rate-based slow start.” As long as there are sufficient packets to send the rate limit doubles each interval, when a rate-decrease occurs (in a congestion epoch), a rate threshold “thresh.”, is set to the new value of the rate limit after the decrease. The function of this variable is similar to the “SSTHRESH” variable used in TCP. While the rate-limit rᵢ tracks the actual departure rate λᵢ, rthreshᵢ serves as an upper bound for slow start. Specifically, the rate limit rᵢ is allowed to increase multiplicatively until it reaches rthreshᵢ or receives a congestion notification. Once the departure rate λᵢ and the rate limit rᵢ are close to rthreshᵢ the latter is allowed to increase linearly by σ/T once per measurement interval T. The dynamics of these variables are illustrated in FIG. 4.

The rate-decrease during a congestion epoch is based upon the measured and smoothed egress rate νᵢ. The response to congestion is to limit the departure rates (λᵢ) to values smaller than νᵢ consistently during the congestion epoch. A method for this is to limit λᵢ by the rate limit parameter rᵢ =λ×νᵢ,0<β<1 upon receipt of congestion feedback. The rate change (increase or decrease) is not performed more than once per measurement interval T. Moreover when there is a sudden large difference between the load λᵢ and the egress rate νᵢ, the present method adds an additional compensation to drain out the possible queue built up in the interior.

The measurement interval T used by all edge systems (both ingress 202 and egress 206) is set to the class-wide maximum edge-to-edge round-trip propagation and transmission delays, max_ertt, plus the time to mark all virtual links passing through the bottleneck when congestion occurs. The time to mark all virtual links can be roughly estimated as Nₘₐₓσ/μₘᵢₙ where μmin is the smallest capacity within the class and Nₘₐₓ is a reasonable bound on the number of virtual links passing through the bottleneck. Since all virtual links use the same interval, they increase with roughly the same acceleration and will all backoff within T of being marked. The bound is not a function of RTT partly due to the fact that the rate limit increases by at most σ/T in every interval T, thus “acceleration” varies with the inverse of delay.

To improve fairness in the system, the method optionally delays backoff through a method known as “delayed feedback response.” Specifically, the feedback received by the ingress node 202 is enforced after a delay of max_ertt−ertt_{i,}, where erttᵢ is the edge-to-edge round trip of the i-th virtual link. This step attempts to roughly equalize the time-delay inherent in all the feedback loops of the traffic control class.

Lasdy, to quickly adjust to sharp changes in demand or capacity, the ingress 202 backs off by μᵢ/2 when packet loss occurs.

Under a second method, as discussed above, the present invention also provides for edge-to-edge congestion control without interior router 204 involvement, herein referred to as Implicit Edge Control (IEC). IEC infers the congestion state by estimating the contribution of each virtual link to the queue length qᵢ by integrating the difference in ingress and egress rates. When the estimate exceeds a threshold, IEC declares congestion. IEC ends the congestion epoch when the delay on a control packet drops to within E of the minimum measured delay. In all other ways, IEC and Explicit Edge Control (EEC) are identical, as described above.

Using IEC to detect the beginning of a congestion epoch, each virtual link signals congestion when its (contribution (“accumulation”), qᵢ, to the queue length exceeds σ. When all N virtual links contribute an accumulation of σ, the total accumulation is Nσ which is the congestion epoch detection criterion used in the EEC method. The accumulation qᵢ can be calculated using the following observation: Assume a sufficiently large interval τ. If the average input rate during this period τ is λᵢ and the average output rate is νᵢ, the accumulation caused by this flow during the period τ is (λᵢ−νᵢ)×τ. The accumulation measured during this period can be added to a running estimate of accumulation qᵢ which can then be compared against a maximum accumulation reference parameter. More accurately stated:

$$\begin{matrix}{q}_{i} ( t ) = {q}_{i} ( t - τ ) + {\int }_{t - τ}^{t} {λ}_{i} ( T ) ⅆ T - {\int }_{u - τ}^{u} {υ}_{i} ( T ) ⅆ T & ( 2 ) \\ = {q}_{i} ( t - τ ) + ( {\overline{λ}}_{i} [ t - τ , t ] - {\overline{υ}}_{i} [ u - τ , u ] ) τ & ( 3 )\end{matrix}$$

u=t+propagation delay (4)

The average interval for νᵢ is delayed by the propagation delay so that any fluid entering the virtual link by the time t can leave by time u unless it is backlogged. As a result the computation of qᵢ excludes packets in the bandwidth-delay product, if the bandwidth-delay product is constant.

The ingress node 202 sends two control packets in each interval T (but no faster than the real data rate). τ is the inter-departure time of control packets at the sender. In each control packet, the ingress inserts a timestamp and the measured average input rate (λᵢ). The average output rate νᵢ is measured over the time interval between arrivals of consecutive control packets at the egress 206. The egress node 206 now has all the three quantities required to do the computation: (λᵢ−νᵢ)×τ and add it to a running estimate of accumulation. The running estimate of accumulation is also reset at the end of a congestion epoch to avoid propagation of measurement errors.

One way of implementing the control packet flow required for this mechanism without adding extra traffic is for the ingress 202 to piggy-back rate and timestamp information in a shim header on two data packets in each interval T. Interior IP routers ignore the shim headers, while the egress 206 strips them out.

The detection of the end of a congestion epoch, or in general an un-congested network is based upon samples of one-way delay. As each control packet arrives at the egress 202, the egress 202 updates the minimum one-way delay seen so far. Every time a one-way delay sample is withinεof the minimum one-way delay, the egress 206 declares that the network is un-congested and stops sending negative feedback. Note that the minimum one-way delay captures the fixed components of delay such as transmission, propagation and processing (not queuing delays). The delay over and above this minimum one-way delay is a rough measure of queuing delays. Since low delay indicates lack of congestion, the method does not attempt to detect the beginning of a congestion epoch until a control packet has a delay greater thanεabove the minimum delay.

Below are two illustrative applications for the edge-to-edge control of the present invention: distributed buffer management and an end-to-end low-loss best effort service.

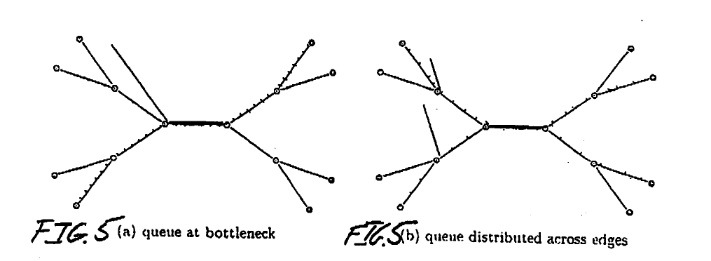

As already stated, edge-to-edge control can be used to distribute backlog across the edges, as illustrated in FIGS. 5(a) and 5(b). This increases the effective number of buffers allowing more TCP connections to obtain large enough windows to survive loss without timing out. This reduces TCP's bias against tiny flows and thus improves fairness. Using IEC to distribute the backlog dramatically reduces the coefficient of variation in goodput (“goodput” is defined herein as the number of transmitted payload bits excluding retransmissions per unit time) when many TCP connections compete for the bottleneck. As expected, this improvement increases as congestion is distributed across more edges.

Edge-to-edge control can also be combined with Packeteer TCP rate control (TCPR) to provide a low-loss-end-to-end service for TCP connections. By “low-loss” it is meant that the method typically does not incur loss in the steady-state. Furthermore as with IEC alone, the combined IED +TCPR method does not require upgrading either end-systems or the interior network.

In this combined method, IEC pushes the congestion to the edge and then TCP rate control pushes the congestion from the edge back to the source. To accomplish this method, the virtual link ascertains the available capacity at the bottleneck and provides this rate to the TCP rate controller. The TCP rate controller then converts the rate to the appropriate window size and stamps the window size in the receiver advertised window of acknowledge heading back to the source.

Thus, both the Explicit Edge Control (EEC) and the Implicit Edge Control (IEC) methods can be deployed one class at a time improving performance as the number of edge controlled class increases. For example, deployment can be piggybacked with the roll-out of services or MPLS, since these techniques can work with either architecture. Both methods are transparent to end-systems, but require software components to be installed at the edges of the network. Such edge components can be installed as upgrades to routers or stand-alone units.

Hence, the above described apparatus and method provide for an improved data network by elevating congestion at network bottlenecks.

Although the invention has been described above in connection with exemplary embodiments, it is apparent that many modifications and substitutions can be made without departing from the spirit or scope of the invention. Accordingly, the invention is not to be considered as limited by the foregoing description, but is only limited by the scope of the appended claims.

What is claimed is:

1. A method for improving distributing traffic congestion at a node, said method comprising:
determining a congestion epoch occurring at a node by measuring the queue length at said node; and
redistributing congestion at said node to at least one other node at an edge of said node when said measured queue length at said node exceeds a predetermined threshold value in response to an output of an ingress node.

2. The method of claim 1, wherein said node determines said occurrence of said congestion epoch.

3. The method of claim 2, wherein said node marks a congestion bit on at least one packet when said measured queue length at said node exceeds a predetermined threshold value.

4. The method of claim 1, wherein said node determines an end to said occurrence of said congestion epoch.

5. The method of claim 1, wherein said node sends at least one control signal to one or more of said at least one other nodes to redistribute the congestion at said node.

6. The method of claim 5, wherein said other nodes comprise ingress edge nodes.

7. The method of claim 1, wherein said node is an interior node.

8. The method of claim 1, wherein said interior node is a router.

9. The method of claim 1, wherein a plurality of said other nodes on an edge of said node collectively detect said occurrence of said congestion epoch.

10. The method of claim 9, wherein said plurality of other nodes comprise egress nodes.

11. The method of claim 9, wherein a plurality of said other nodes collectively detect said occurrence of said congestion epoch when a prediction of said measured queue length at said node exceeds a predetermined threshold value of accumulation at all of said ingress edges.

12. The method of claim 11, wherein said plurality of other nodes comprise egress nodes.

13. The method of claim 1, wherein a plurality of said other nodes determine an end to said occurrence of said congestion epoch.

14. The method of claim 13, wherein said plurality of other nodes comprise egress nodes.

15. The method of claim 9, wherein said plurality of other nodes send at least one control signal to one or more of said ingress nodes to redistribute the congestion at said node.

16. The method of claim 15, wherein said plurality of other nodes comprise egress nodes.

17. A method for improving distributing traffic congestion at a network node for applying stateful mechanisms at the edges, said method comprising:
determining a congestion epoch occurring at a interior node of a network by measuring a queue length at said interior node; and
redistributing congestion at said interior node to at least one other node at an edge of said network when said measured queue length at said interior node exceeds a predetermined threshold value of said interior node in response to an output of an ingress node.

18. The method of claim 17, wherein said interior node determines said occurrence of said congestion epoch.

19. The method of claim 18, wherein said interior node marks a congestion bit on at least one packet when said measured queue length at said interior node exceeds a predetermined threshold value.

20. The method of claim 17, wherein said interior node determines an end to said occurrence of said congestion epoch.

21. The method of claim 17, wherein said interior node sends at least one control signal to one or more of said other nodes to redistribute the congestion at said interior node.

22. The method of claim 18, wherein said other nodes comprise ingress edge nodes.

23. The method of claim 17 wherein said interior node is an interior router.

24. The method of claim 17, wherein a plurality of said other nodes on an edge of said network collectively detect said occurrence of said congestion epoch at said interior node.

25. The method of claim 24, wherein said plurality of other nodes comprise egress nodes.

26. The method of claim 17, wherein a plurality of said other nodes collectively detect said occurrence of said congestion epoch when a prediction of said measured queue length at said interior node exceeds a predetermined threshold value of accumulation at all of said ingress edges.

27. The method of claim 26, wherein said plurality of other nodes comprise egress nodes.

28. The method of claim 17, wherein a plurality of said other nodes determine an end to said occurrence of said congestion epoch.

29. The method of claim 28, wherein said plurality of other nodes comprise egress nodes.

30. The method of claim 17 wherein said plurality of other nodes send at least one control signal to one or more of said ingress nodes to redistribute the congestion at said node.

31. The method of claim 30, wherein said plurality of other nodes comprise egress nodes.

32. An apparatus for improving distributing traffic congestion, said apparatus comprising:
means for determining a congestion epoch occurring at a node by measuring the queue length at said node; and
means for redistributing congestion at said node to at least one other node at an edge of said node when said measured queue length at said node exceeds a predetermined threshold value in response to an output of an ingress node.

33. The apparatus of claim 32, wherein said means for determining a congestion epoch comprises marking a congestion bit on at least one packet when said measured queue length at said node exceeds a predetermined threshold value.

34. The apparatus of claim 32, wherein said means for determining a congestion epoch comprises determining an end to said occurrence of said congestion epoch.

35. The apparatus of claim 32, wherein said means for redistributing congestion comprises sending at least one control signal to one or more of said at least one other nodes to redistribute the congestion at said node.

36. The apparatus of claim 35, wherein said other nodes comprise ingress edge nodes.

37. The apparatus of claim 32, wherein said node is an interior node.

38. The apparatus of claim 32, wherein said interior node is a router.

39. The apparatus of claim 32, wherein said means for determining a congestion epoch comprises collectively detecting said occurrence of said congestion epoch by a plurality of said other nodes on an edge of said node.

40. The apparatus of claim 39, wherein said plurality of other nodes comprise egress nodes.

41. The apparatus of claim 32, wherein said means for determining a congestion epoch comprises collectively detecting said occurrence of said congestion epoch by a plurality of said other nodes on an edge of said node when a prediction of said measured queue length at said node exceeds a predetermined threshold value of accumulation at all of said ingress edges.

42. The apparatus of claim 41, wherein said plurality of other nodes comprise egress nodes.

43. The apparatus of claim 32, wherein said means for determining a congestion epoch comprises determining an end to said occurrence of said congestion epoch by a plurality of said other nodes on an edge of said node.

44. The apparatus of claim 43, wherein said plurality of other nodes comprise egress nodes.

45. The apparatus of claim 32, wherein said means for redistributing said congestion comprises sending at least one control signal by said plurality of other nodes to one or more of said ingress nodes to redistribute the congestion at said node.

46. The apparatus of claim 45, wherein said plurality of other nodes comprise egress nodes.
